(19) United States
(12) Patent Application Publication
(10) Pub. No.: US 2018/0046352 A1
(43) Pub. Date: Feb. 15, 2018

(54) VIRTUAL CURSOR MOVEMENT

(71) Applicants: Matthew Johnson, Kirkland, WA (US); Aaron Mackay Burns, Newcastle, WA (US); Donna Long, Redmond, WA (US); Benjamin John Sugden, Redmond, WA (US); Bryant Hawthorne, Duvall, WA (US)

(72) Inventors: Matthew Johnson, Kirkland, WA (US); Aaron Mackay Burns, Newcastle, WA (US); Donna Long, Redmond, WA (US); Benjamin John Sugden, Redmond, WA (US); Bryant Hawthorne, Duvall, WA (US)

(21) Appl. No.: 15/232,607

(22) Filed: Aug. 9, 2016

(51) Int. Cl. G06F 3/0481; G06T 19/00

(52) U.S. Cl. CPC G06F 3/04815; G06F 3/04812; G06T 19/006

(57) ABSTRACT

A method for moving a virtual cursor on a virtual reality computing device including a display comprises presenting a virtual cursor at a first screen-space position that occludes a world-space position of a first object, the virtual cursor having a first world-space position based on the first screen-space position and the world-space position of the first object. Based on receiving an input, the method includes moving the virtual cursor from the first screen-space position to a second screen-space position that occludes a world-space position of a second object, the virtual cursor having a second world-space position based on the second screen-space position and the world-space position of the second object. While the virtual cursor is presented at an intermediate screen-space position, the method includes assigning an intermediate world-space position based on the intermediate screen-space position and simulated attractive forces for each of the first and second objects.

### BACKGROUND

Head mounted display devices (HMDs) can be used to provide augmented reality (AR) experiences and/or virtual reality (VR) experiences by presenting virtual imagery to a user via a near-eye display. The virtual imagery may be manipulated by the user and/or otherwise interacted with in a variety of ways.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for moving a virtual cursor on a virtual reality computing device including a near-eye display includes presenting a virtual cursor at a first screen-space position that occludes a world-space position of a first object, the virtual cursor having a first world-space position based on the first screen-space position and the world-space position of the first object. Based on receiving an input, the method includes moving the virtual cursor from the first screen-space position to a second screen-space position that occludes a world-space position of a second object, the virtual cursor having a second world-space position based on the second screen-space position and the world-space position of the second object. While the virtual cursor is presented at an intermediate screen-space position, the method includes assigning an intermediate world-space position based on the intermediate screen-space position and simulated attractive forces for each of the first and second objects.

### BRIEF DESCRIPTION OF THE DRAWINGS

FIG. 1 schematically shows a user viewing virtual imagery in a real-world environment via a virtual reality computing device.

FIGS. 2A and 2B schematically illustrate presentation of virtual imagery to a user of a virtual reality computing device.

FIG. 3 illustrates an example method for moving a virtual cursor on a virtual reality computing device including a near-eye display.

FIGS. 4A-4D schematically illustrate movement of a virtual cursor.

FIGS. 5A-5C schematically illustrate smoothing of virtual cursor movement.

FIG. 6 illustrates an example method for sending spatial coordinates for a virtual cursor to a second virtual reality computing device.

FIG. 7 illustrates an example method for presenting a virtual cursor corresponding to received spatial coordinates.

FIG. 8 schematically shows an example virtual reality computing device.

FIG. 9 schematically shows an example computing system.

### DETAILED DESCRIPTION

A virtual or augmented reality computing device may present a virtual cursor at a particular screen-space position on a near-eye display. The virtual cursor may be presented so as to appear to occupy a three-dimensional world-space position some distance away from the user. The user may move and control the cursor in order to interact with any virtual imagery presented by the virtual or augmented reality computing device. Assigning a real world depth to the cursor position can be challenging. However, it may often be important for a virtual cursor to have a real-world depth consistent with a user's expectations, especially when the cursor is viewed by other users from different vantage points.

Accordingly, the present disclosure is directed to an approach for moving a virtual cursor through three-dimensional space, where a depth of the virtual cursor is calculated in part based on simulated attractive forces exerted by objects in the user's environment. According to this approach, a virtual cursor may be presented by a virtual or augmented reality computing device at any of a plurality of potential screen-space positions. From some of these screen-space positions, the virtual cursor may, from the user's perspective, occlude real or virtual objects present in the user's environment. For each screen-space position of the virtual cursor, a depth of a three-dimensional world-space position may be assigned to the virtual cursor based on a distance between the near-eye display and any objects that the virtual cursor is occluding from the user's perspective (i.e., a real world depth of an object occluded by the cursor may be assigned to the cursor).

While the virtual cursor occupies an intermediate screen-space position between objects, objects near the virtual cursor may exert simulated attractive forces on the cursor, and a depth of a three-dimensional world-space position assigned to the cursor can be based on these forces. For example, while the cursor is presented at an intermediate screen-space position near, though not occluding, a particular object, the virtual cursor may be assigned a three-dimensional world-space position having a depth substantially similar to the particular object. As the virtual cursor moves to a different screen-space position near a different object, a depth of the cursor's three-dimensional world-space position may be gradually changed to match the depth of the new object. As such, the virtual cursor will move in a pleasing manner to other users viewing the virtual cursor movement, for example, from a different perspective.

As will be described below, a simulated attractive force may be applied to a virtual cursor in a variety of suitable ways. For example, the magnitude of a simulated attractive force exerted by an object on a virtual cursor may be proportional to a shortest distance between the object and a ray intersecting the virtual cursor. Two or more objects may contribute to the net simulated attractive force. Additionally, or alternatively, the magnitude of the simulated attractive force may be set such that only a nearest object contributes to the net simulated attractive force. In other words, the simulated attractive force of all but the closest object can be set to zero. As such, the three-dimensional world-space position of the virtual cursor may be dynamically changed to occupy a depth corresponding to whichever object the virtual cursor is closest. In either implementation, the rate at which the virtual cursor moves to a new depth may be capped, such that motion of the virtual cursor may be easily followed by observers.

A user may move the two-dimensional screen space position of the virtual cursor by providing two-dimensional inputs, such as via a mouse, trackball, trackpad, or other two-dimensional input device. Thus the user need not provide explicit input to control the cursor depth, as the cursor depth may be based on the position of real and virtual objects relative to the cursor. However, in some implementations, a user may provide an explicit three-dimensional input that at least partially controls the depth of the cursor. In such implementations, the depth controlling methods discussed herein may be blended with the explicit three-dimensional user control so that cursor depth is at least partially based on proximity to real or virtual objects. As used herein, “depth” often refers to the coordinate that is perpendicular to the screen and/or parallel with the optical axis of the display. However, this coordinate may be transformed to any coordinate system, such as a shared coordinate system cooperatively used by two or more virtual reality computing devices.

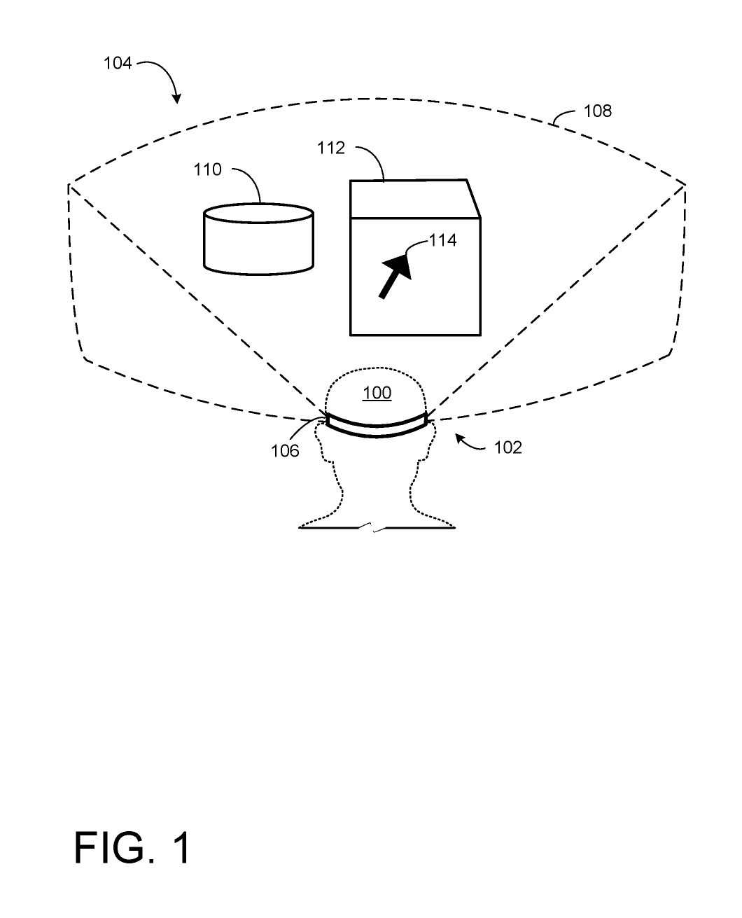

FIG. 1 schematically shows a user 100 wearing a virtual reality computing device 102, and viewing a real-world environment 104. Virtual reality computing device 102 may be an augmented reality computing device that allows user 100 to directly view the real-world environment through a partially transparent near-eye display, or virtual reality computing device 102 may be fully opaque and present imagery of real-world environment 104 as captured by a front-facing camera. To avoid repetition, experiences provided by both implementations, as well as purely virtualized implementations in which the real world is not visible, are referred to as “virtual reality” and the computing devices used to provide the augmented or purely virtualized experiences are referred to as virtual reality computing devices.

Virtual reality computing device 102 includes a near-eye display 106 through which user 100 has a field of view 108 of real-world environment 104. Near-eye display 106 may be at least partially transparent, such that light from real-world environment 104 may pass through near-eye display 106 and reach the eyes of user 100. Accordingly, any virtual imagery generated by the virtual reality computing device and presented via near-eye display 106 may appear to augment the user's real-world surroundings.

As shown, first object 110 and second object 112 are visible within field of view 108. One or both of objects 110 and 112 may be physical objects present in real-world environment 104. Notably, other physical objects may be present in real-world environment 104 that are not shown in FIG. 1, and such objects may or may not exert a simulated attractive force on a virtual cursor. For example, the virtual reality computing device may identify physical objects in the real-world environment, and perform background removal to prevent classes of objects, such as walls, floors, and/or other surfaces, objects greater than a threshold distance away, objects which the user has explicitly excluded, etc., from influencing virtual cursor movement. Alternatively, one or both of objects 110 and 112 may be virtual objects generated by the virtual reality computing device and displayed via the near-eye display. In general, any references to “objects” as used herein may refer to either physical objects in the user's environment, and/or virtual objects generated by a virtual reality computing device, and each type of object may exert a simulated attractive force on a virtual cursor, as will be described below. Further it will be appreciated that any number of objects may be present, and that only two objects are illustrated and described for the sake of simplicity.

In some implementations, virtual objects generated by a virtual reality computing device may be assigned fixed three-dimensional world-space positions relative to a user's real-world environment. In other words, such objects may be “world-locked,” and always displayed at their assigned position, even as the user moves throughout the environment. Additionally, or alternatively, virtual objects may be “body-locked” and move with the user. For example, a virtual object may be persistently displayed at a certain position relative to the user, and match the user's movements in order to maintain this relative position.

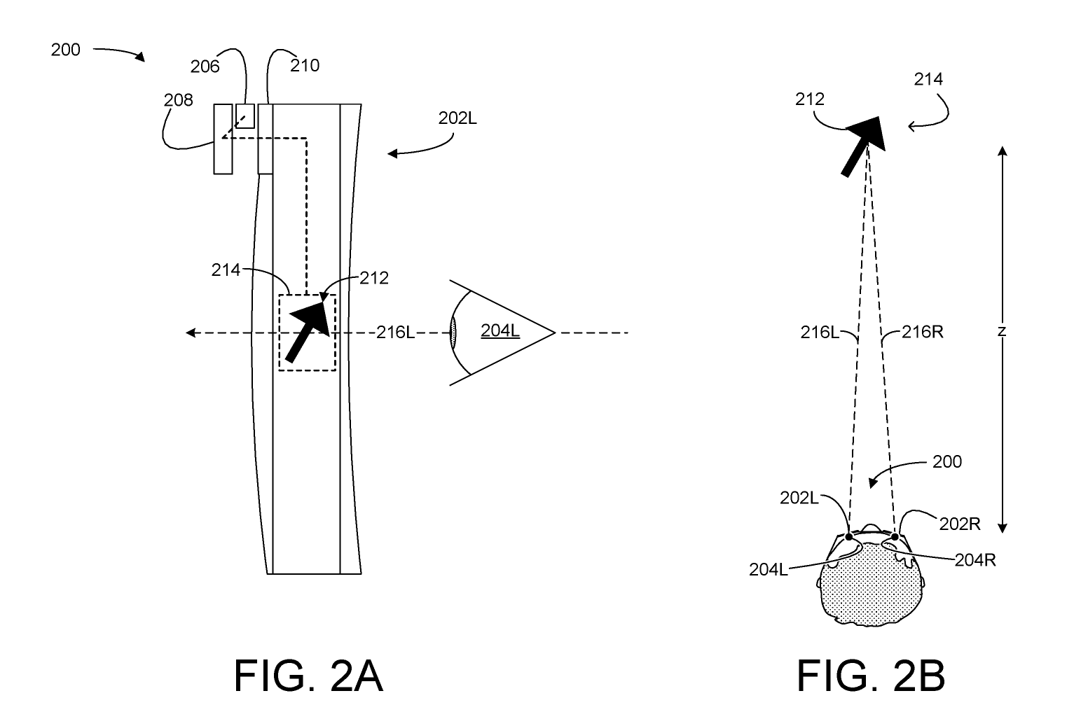

Also shown in FIG. 1 is a virtual cursor 114. Virtual cursor 114 may be generated by virtual reality computing device 102 and presented at a particular screen-space position via near-eye display 106, as will be described below with respect to FIG. 2. It will be appreciated that any virtual imagery shown in real-world environment 104, including at least virtual cursor 114, will only be visible from the perspective of a user of a virtual reality computing device. In other words, FIG. 1 includes imagery that can only be seen by use of virtual reality computing device 102 or another virtual reality computing device cooperating with virtual reality computing device 102 to provide a shared virtual reality experience.

Responsive to user input, the virtual reality computing device may move virtual cursor 114 to any of a plurality of potential screen-space positions. Further, for each screen-space position of virtual cursor 114, the virtual reality computing device may assign a three-dimensional world-space position having a depth corresponding to the screen-space position and any objects that the virtual cursor is near/occluding from the user perspective. As will be described below, this depth may dynamically change as the user moves the virtual cursor across the near-eye display.

In some implementations, the near-eye display associated with a virtual reality computing device may include two or more microprojectors, each configured to project light on or within the near-eye display. FIG. 2A shows a portion of an example near-eye display 200. Near-eye display 200 includes a left microprojector 202L situated in front of a user's left eye 204L. It will be appreciated that near-eye display 200 also includes a right microprojector 202R situated in front of the user's right eye 204R, not visible in FIG. 2A.

The near-eye display includes a light source 206 and a liquid-crystal-on-silicon (LCOS) array 208. The light source may include an ensemble of light-emitting diodes (LEDs)—e.g., white LEDs or a distribution of red, green, and blue LEDs. The light source may be situated to direct its emission onto the LCOS array, which is configured to form a display image based on control signals received from a logic machine associated with a virtual reality computing device. The LCOS array may include numerous individually addressable pixels arranged on a rectangular grid or other geometry. In some embodiments, pixels reflecting red light may be juxtaposed in the array to pixels reflecting green and blue light, so that the LCOS array forms a color image. In other embodiments, a digital micromirror array may be used in lieu of the LCOS array, or an active-matrix LED array may be used instead. In still other embodiments, transmissive, backlit LCD or scanned-beam technology may be used to form the display image.

In some embodiments, the display image from LCOS array 208 may not be suitable for direct viewing by the user of near-eye display 200. In particular, the display image may be offset from the user's eye, may have an undesirable vergence, and/or a very small exit pupil (i.e., area of release of display light, not to be confused with the user's anatomical pupil). In view of these issues, the display image from the LCOS array may be further conditioned en route to the user's eye. For example, light from the LCOS array may pass through one or more lenses, such as lens 210, or other optical components of near-eye display 200, in order to reduce any offsets, adjust vergence, expand the exit pupil, etc.

Light projected by each microprojector 202 may take the form of a virtual image visible to a user, and occupy a particular screen-space position relative to the near-eye display. As shown, light from LCOS array 208 is forming virtual image 212 at screen-space position 214. Specifically, virtual image 212 is a virtual cursor, though any other virtual imagery may be displayed instead of and/or in addition to a virtual cursor. A similar image may be formed by microprojector 202R, and occupy a similar screen-space position relative to the user's right eye. In some implementations, these two images may be offset from each other in such a way that they are interpreted by the user's visual cortex as a single, three-dimensional image. Accordingly, the user may perceive the images projected by the microprojectors as a single virtual cursor, or other object, occupying a three-dimensional world-space position that is behind the screen-space position at which the virtual image is presented by the near-eye display. In other words, a virtual cursor may occupy a three-dimensional world-space position some distance away from the user that is intersected by a virtual ray 216 that extends from the user's eye 204L and through the screen-space position 214 of the virtual image 212. Further, movement of virtual image 212 to a different screen-space position relative to the near-eye display may cause the virtual cursor to appear from the user's perspective to move to a different three-dimensional world-space position.

This is shown in FIG. 2B, which shows an overhead view of a user wearing near-eye display 200. As shown, left microprojector 202L is positioned in front of the user's left eye 204L, and right microprojector 202R is positioned in front of the user's right eye 204R. Virtual image 212 is visible to the user as a virtual cursor present at a three-dimensional world-space position 214 at a virtual depth Z. As with FIG. 1, FIG. 2B includes virtual imagery that would only be visible to the user of the virtual reality computing device.

Virtual cursor 212 is intersected by two rays 216L and 216R, extending from the user's left and right eyes respectively. As described above, a virtual ray may extend from a user's eye, through a screen-space position at which a virtual image is presented on a near-eye display, and intersect the three-dimensional virtual position at which the virtual cursor appears to the user. As will be described below, the virtual depth Z at which the virtual cursor is presented may dynamically change as the virtual cursor moves. For example, the virtual depth of the virtual cursor may be calculated based on the current screen-space position of the virtual cursor, as well as any objects that the virtual cursor is near to from the user's perspective.

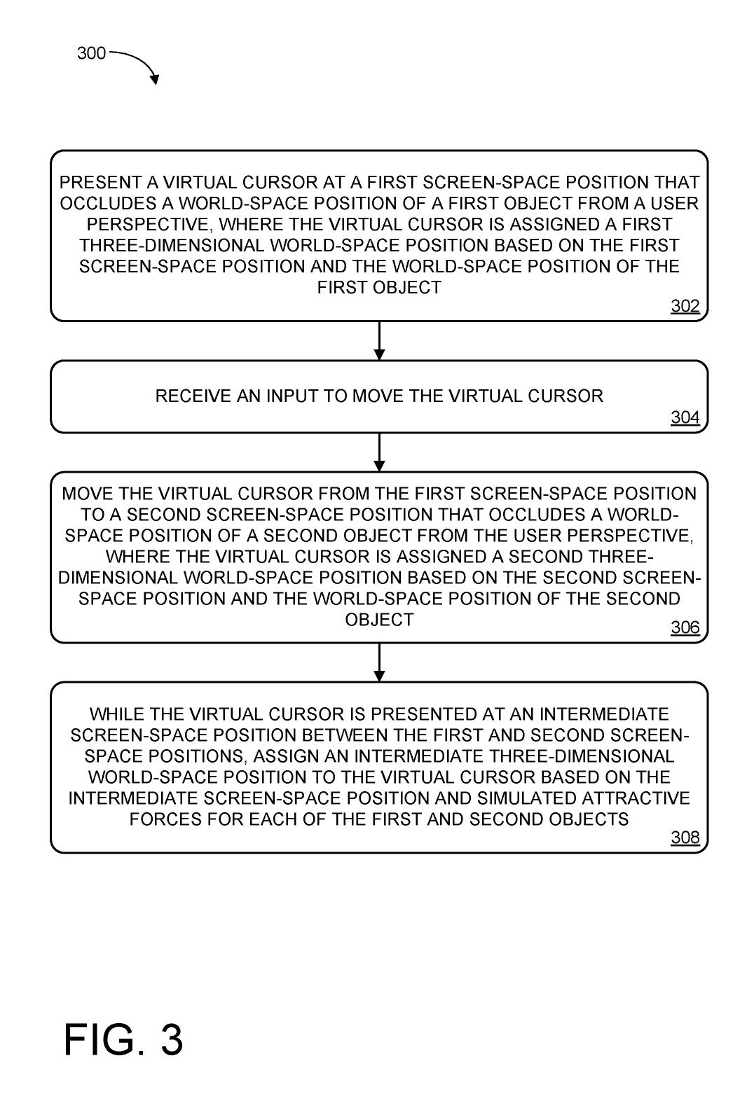

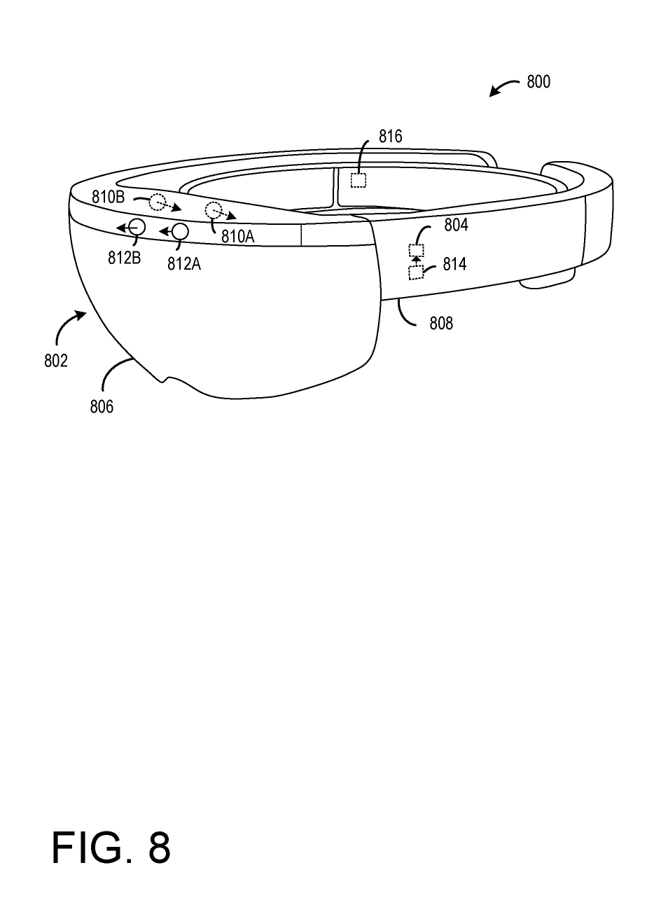

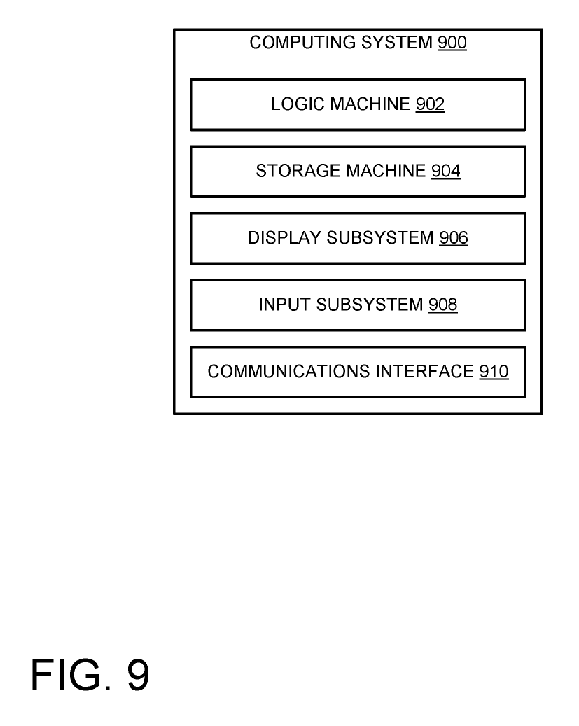

FIG. 3 illustrates an example method 300 for moving a virtual cursor on a virtual reality computing device including a near-eye display. For example, the method 300 may be performed by the virtual reality computing device of FIG. 1, a virtual reality computing device associated with near-eye display 200 of FIG. 2, the virtual reality computing device 800 of FIG. 8, and/or the computing system 900 of FIG. 9. In general, method 300 may be performed by any computing device suitable for generating and/or displaying virtual reality content.

At 302, method 300 includes presenting a virtual cursor at a first screen-space position that occludes a world-space position of a first object from a user perspective, where the virtual cursor is assigned a first three-dimensional world-space position based on the first screen-space position and the world-space position of the first object.

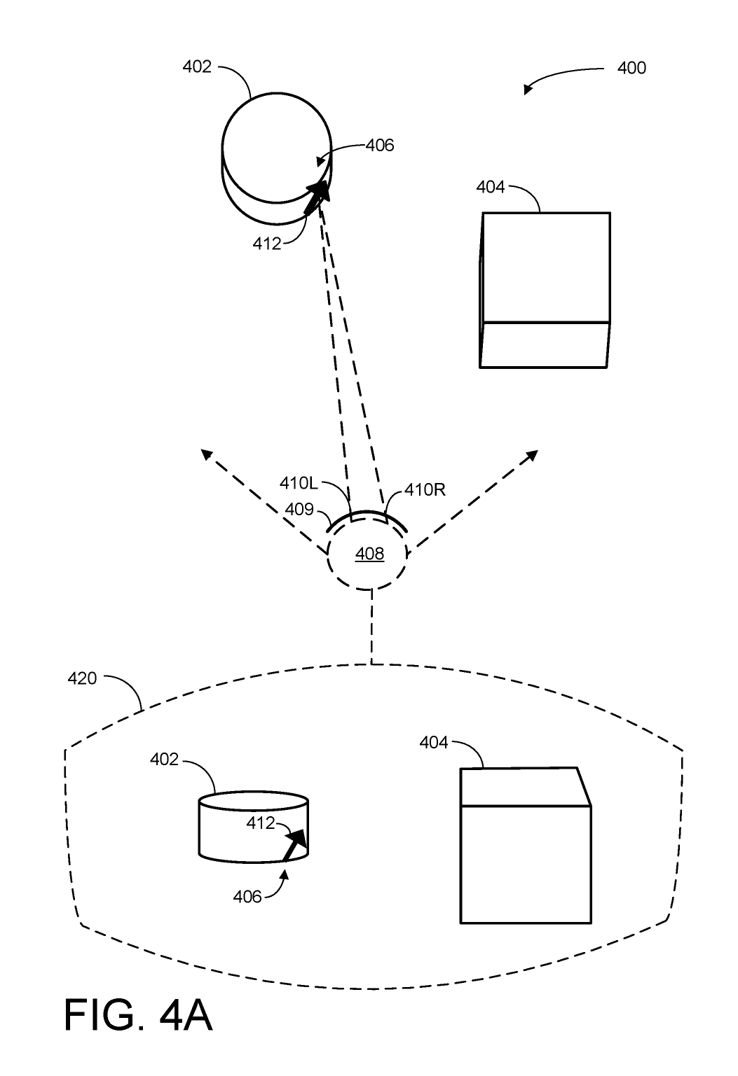

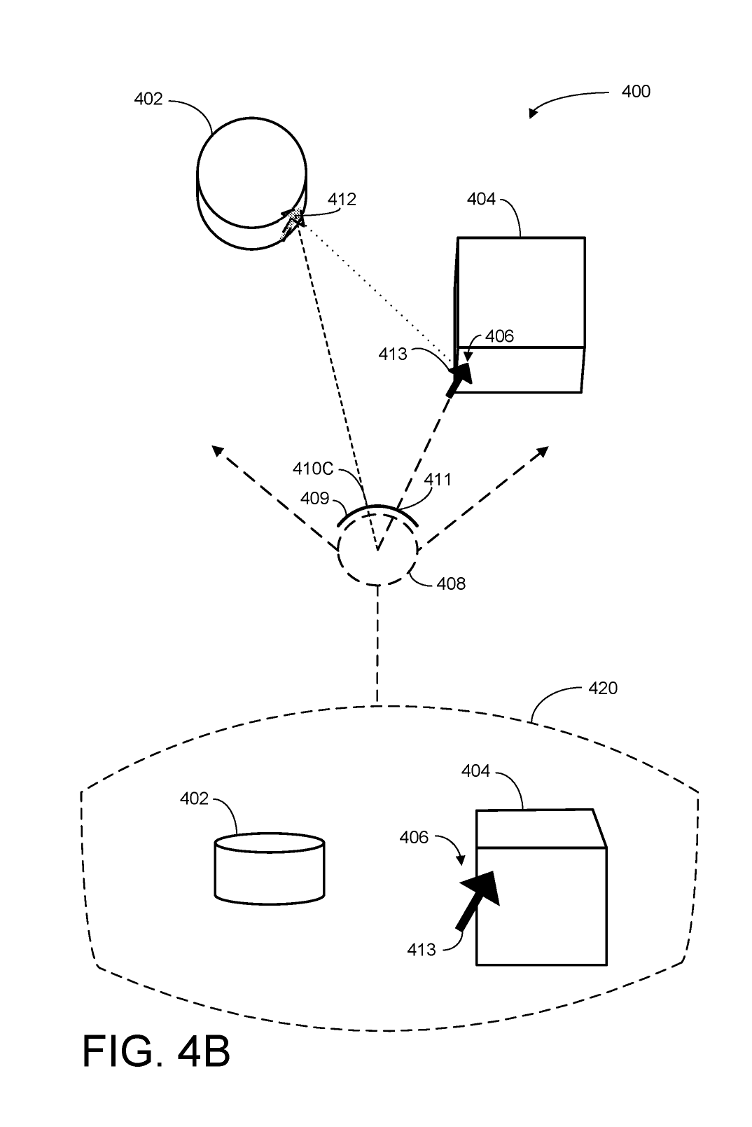

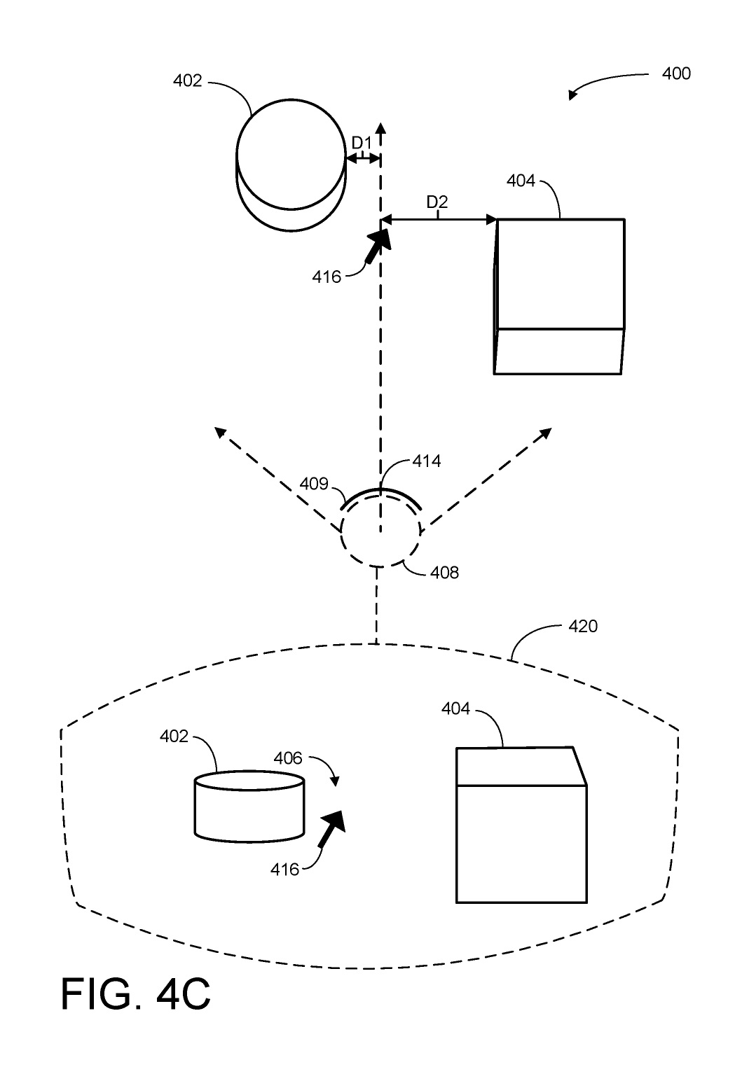

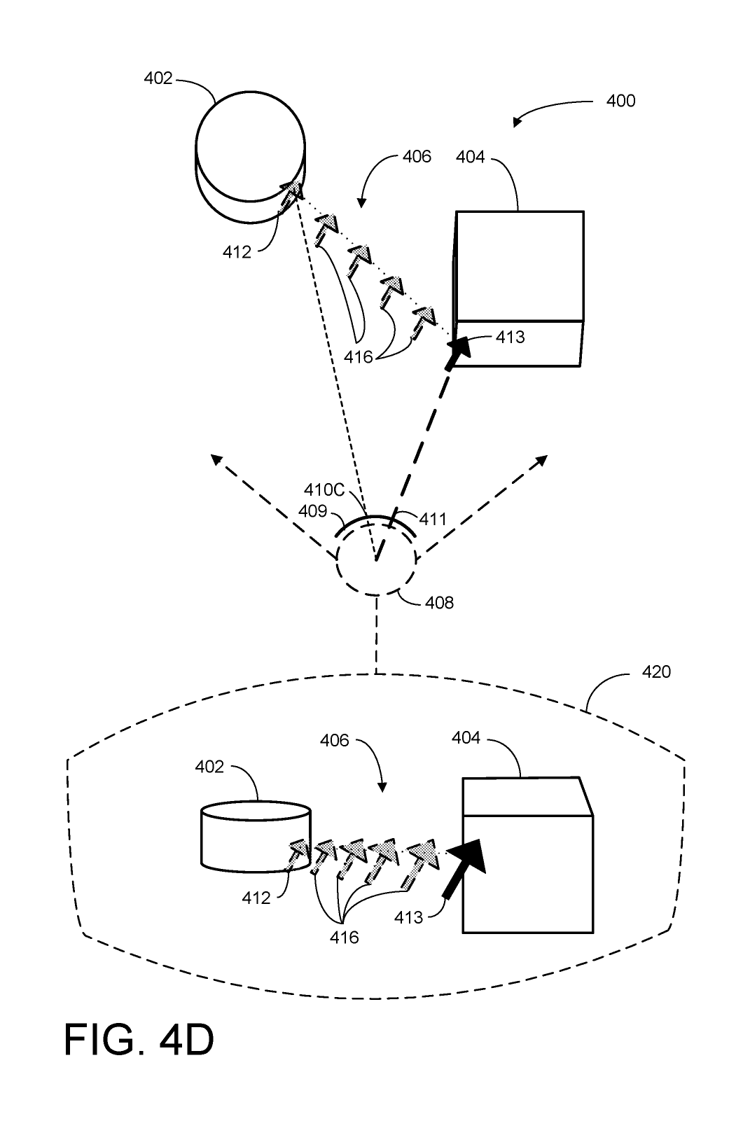

This is schematically shown in FIG. 4A. FIG. 4A shows an environment 400 including a first object 402 and a second object 404. Also shown is a virtual cursor 406. A user 408 is observing environment 400 via a near-eye display 409 of a virtual reality computing device. As with environment 104 of FIG. 1, some virtual imagery is shown in environment 400 that is only visible to users of virtual reality computing devices.

Virtual cursor 406 is being presented by near-eye display 409 at screen-space positions 410L and 410R. Virtual images of the cursor presented at the two screen-space positions are fused in the user's visual cortex, causing the user to perceive the virtual cursor as occupying first three-dimensional world-space position 412. As shown, two virtual rays are extending from user 408, through near-eye display 409, and intersecting virtual cursor 406. Similar to the virtual rays 216 shown in FIG. 2B, these rays are extending from the left and right eyes of user 408. Specifically, a virtual ray extends from the left eye of user 408, through screen-space position 410L of near-eye display 409, and intersects the first three-dimensional world-space position 412 of virtual cursor 406. A similar virtual ray extends from the right eye of user 408, through screen-space position 410R, and intersects position 412.

FIG. 4A also includes a field of view 420, which is shown from the perspective of user 408 via near-eye display 409. In other words, field of view 420 is shown as user 408 would perceive environment 400, after virtual imagery presented by the near-eye display is interpreted in the user's visual cortex. Based on the virtual cursor being presented at screen-space positions 410L and 410R, the virtual cursor appears to occupy first three-dimensional world-space position 412. In other words, cursor 406 is presented by the virtual reality computing device so as to appear from the user perspective to occupy the first three-dimensional virtual position.

Three-dimensional world-space position 412 is located a certain distance—i.e., a virtual depth—away from user 408. This virtual depth is set approximately equal to the distance between user 408 and first object 402. Accordingly, the three-dimensional world-space position is determined based on the screen-space position of the virtual cursor, and the world-space position of the first object.

In some implementations, world-space positions may be defined by a virtual reality computing device in terms of spatial coordinates. For example, a three-dimensional world-space position of a virtual cursor may be defined by at least three spatial coordinates, constituting three degrees-of-freedom (3DOF). Additionally, or alternatively, a three-dimensional world-space position may be defined by one or more additional spatial coordinates, defining one or more of a pitch, roll, and/or yaw of a virtual cursor, for up to six degrees-of-freedom precision (6DOF).

At 304, method 300 of FIG. 3 includes receiving an input to move the virtual cursor. A user of a virtual reality computing device may provide an input to move a virtual cursor in any number of ways. For example, the user may make use of one or more input devices, such as computer mice, trackpads, touch-sensitive displays, joysticks, video game controllers, etc. Additionally, or alternatively, the user may control the virtual cursor via gestures, detected via a camera included in a virtual reality computing device, for example, and/or via voice control as detected via one or more microphones. Furthermore, in some implementations, the virtual reality computing device may be configured to automatically move the virtual cursor, as part of a three-dimensional holographic animation, virtual game, etc. As introduced above, the input to move the virtual cursor may be a two-dimensional input.

At 306, method 300 includes moving the virtual cursor from the first screen-space position to a second screen-space position that occludes a world-space position of a second virtual object from the user perspective, where the virtual cursor is assigned a second three-dimensional world-space position based on the second screen-space position and the world-space position of the second object.

This is schematically shown in FIG. 4B. In FIG. 4B, the virtual cursor is presented by the near-eye display at a screen-space position 411, and the virtual cursor occupies a second three-dimensional world-space position 413. The second three-dimensional world-space position is intersected by a single virtual ray, extending from the center of the circle representing user 408 and passing through screen-space position 411 of the near-eye display. It will be appreciated that, for any given three-dimensional world-space position, the virtual cursor 406 may be presented by the near-eye display at two different screen-space positions, one in front of each of the user's eyes. However, throughout the rest of the disclosure, each three-dimensional world-space position of the virtual cursor will be described as corresponding to a single screen-space position, and this will be reflected in the figures. This is done for the sake of simplicity.

For example, In FIG. 4A, two virtual rays are shown extending from the user's eyes, passing through two screen-space positions 410L and 410R, and intersecting the first three-dimensional world-space position. However, in FIG. 4B, a single virtual ray extends from user 408, passes through a composite screen-space position 410C, and intersects the outline of the first three-dimensional world-space position. This composite screen-space position will be referred to as the first screen-space position of the virtual cursor, while screen-space position 411 will be referred to as the second screen-space position.

FIG. 4B shows environment 400 after virtual cursor 406 has moved from the first screen-space position to second screen-space position 411. Accordingly, the three-dimensional world-space position of the virtual cursor has moved from first three-dimensional world-space position 412 to second three-dimensional world-space position 413. FIG. 4B includes an outline of virtual cursor 406 at first three-dimensional world-space position 412 as a visual reference, even though the virtual cursor is no longer visible to the user at that position. The dotted line between position 412 and position 413 indicates movement of the virtual cursor in three-dimensional space.

FIG. 4B again includes field of view 420 showing environment 400 from the perspective of user 408. Based on the virtual cursor being presented at screen-space position 411, the virtual cursor appears to occupy second three-dimensional world-space position 413. In other words, cursor 406 is presented by the virtual reality computing device so as to appear from the user perspective to occupy the second three-dimensional virtual position. As with the first three-dimensional world-space position, second three-dimensional world-space position 413 is assigned based on the second screen-space position 411 of the virtual cursor, as well as the world-space position of the second object. Specifically, the virtual depth of the virtual cursor matches the distance between user 408 and the second object, because the virtual cursor is occluding the second object from the user's perspective.

Because object 404 is closer to the user than object 402, the size of cursor 406 from the user's perspective has increased relative to the field of view shown in FIG. 4A. In this manner, the virtual cursor may mimic a real three-dimensional object, in that its perceived size is dependent on its proximity to the observer. In other words, at the second screen-space position, virtual cursor 406 is presented so as to appear from the user perspective to occupy a second three-dimensional virtual position having a different virtual depth than the first three-dimensional virtual position.

At 308, method 300 of FIG. 3 includes, while the virtual cursor is presented at an intermediate screen-space position between the first and second screen-space positions, assigning an intermediate three-dimensional world-space position to the virtual cursor based on the intermediate screen-space position and simulated attractive forces for each of the first and second objects.

This is schematically illustrated in FIG. 4C. FIG. 4C again shows environment 400, including objects 402 and 404, as well as virtual cursor 406. In FIG. 4C, virtual cursor 406 is presented by near-eye display 409 at intermediate screen-space position 414, which is between the first and second screen-space positions. Also shown in FIG. 4C is field of view 420 that shows that, from the perspective of user 408, virtual cursor 406 is not occluding object 402 or object 404. Accordingly, virtual cursor 406 is assigned intermediate three-dimensional world-space position 416 based on the intermediate screen-space position and simulated attractive forces exerted by objects in the environment. In other words, the virtual cursor is presented such that it appears to occupy an intermediate three-dimensional virtual position at an intermediate virtual depth.

Intermediate three-dimensional world-space position 416 is positioned between the first and second three-dimensional world-space positions. In FIG. 4C, the intermediate three-dimensional world-space position of cursor 406 is shown as being intersected by a single virtual ray, which passes through intermediate screen-space position 414. As described above, only a single virtual ray is shown in FIG. 4C for the sake of simplicity. It will be appreciated that, as with FIGS. 2B and 4A, the three-dimensional world-space position of the virtual cursor may be intersected by two different virtual rays, one extending from each of the user's eyes.

A depth of the intermediate three-dimensional world-space position—i.e., its position along the virtual ray—may be determined based on simulated attractive forces exerted on the virtual cursor by each of first object 402 and second object 404. In other words, the position of the virtual cursor along two axes—i.e., the screen-space position—may be specified by user input, while the depth of the virtual cursor (relative to the third axis) is calculated based on the simulated attractive forces. In other words, the first and second objects may be described as having a “gravity-like” effect on the depth of the virtual cursor.

In some implementations, a magnitude of a simulated attractive force for a particular object is inversely proportional to a shortest distance between the particular object and the ray extending through the intermediate screen-space position. This is shown in FIG. 4C, in which the shortest distance between the virtual ray and first object 402 is distance D1, and the shortest distance between the virtual ray and second object 404 is distance D2. In other words, the simulated attractive force exerted on the virtual cursor by the first object will be stronger than the force exerted by the second object. Accordingly, intermediate three-dimensional world-space position 416 is shown having a depth that is more similar to the first object than to the second object. As the virtual cursor moves toward the second three-dimensional world-space position, the shortest distance D2 between the second object and the virtual ray will decrease, and the magnitude of the force exerted by the second object will increase correspondingly. Similarly, the magnitude of the simulated attractive force exerted by the first object will gradually decrease as the shortest distance D1 between the first object and the virtual ray increases. This causes the depth of the virtual cursor to approach the distance between the second object and the near-eye display as the virtual cursor approaches the second object.

Additionally, or alternatively, the depth of the virtual cursor may be automatically changed to match the depth of the closest object. For example, as a virtual cursor is moved away from the first object, the virtual cursor may continue to have a depth that corresponds to the depth of the first object. Once the virtual cursor reaches a point where the shortest distance between the second object and the virtual ray is shorter than the shortest distance between the first object and the virtual ray, the virtual cursor may move to occupy a depth corresponding to the second object. In some implementations, the rate at which the virtual cursor moves to the new depth may be capped, such that the change in depth is gradual over a short period of time. This may enable observers of the virtual cursor to more easily follow cursor movement as the cursor depth changes.

Additionally, or alternatively, the magnitude of the simulated attractive force for a particular object may be proportional to a size of the particular object. In other words, larger objects may exert a larger simulated attractive force than smaller objects. This may be especially helpful in virtual settings where the user is interacting with one large “primary” object, and a number of smaller “secondary” objects. Other object parameters additionally or alternatively may influence the magnitude of the simulated attractive force. As an example, a prediction algorithm may predict a likelihood that a user intends to target a particular object, and increased likelihood may correspond to increased magnitude of simulated attractive force. As another example, certain classes of objects (e.g., user interface controls such as buttons, sliders, and the like) may be prioritized over other classes of objects (e.g., unidentified real world objects). Virtually any object parameter may be used to calculate a magnitude of a simulated attractive force.

FIG. 4C shows a single intermediate screen-space position for the virtual cursor, and a single corresponding three-dimensional world-space position. However, in some implementations, the virtual cursor may move through a continuous plurality of intermediate screen-space positions, and an intermediate three-dimensional world-space position may be assigned to each of the continuous plurality of screen-space positions. These intermediate three-dimensional world-space positions are determined based on each intermediate screen-space position, and the simulated attractive forces applied by the first and second objects. In other words, the virtual cursor may appear to move continuously from the first three-dimensional world-space position to the second three-dimensional world-space position, without any abrupt skips or jumps.

This is illustrated in FIG. 4D. FIG. 4D again shows environment 400, including first object 402, second object 404, and virtual cursor 406. As shown, the virtual cursor is currently being presented at the second screen-space position 411, and is occupying the second three-dimensional world-space position 413. FIG. 4D also shows an outline of first three-dimensional world-space position 412, being intersected by a virtual ray passing through first screen-space position 410C. Further, FIG. 4D shows a continuous plurality of intermediate three-dimensional world-space positions 416, which the virtual cursor passed through as it moved toward the second world-space position. To clarify, FIG. 4D is not intended to convey that the virtual cursor is presented at multiple positions simultaneously. Rather, FIG. 4D is intended to illustrate the manner in which the virtual cursor may move over time. Specifically, as the virtual cursor moves from the first screen-space position to the second screen-space position, its motion is continuous—i.e., there are no sudden skips or jumps. Movement of the virtual cursor is again indicated by the dotted line connecting the outline of position 412 to position 413.

In some implementations, a virtual reality computing device may be configured to send spatial coordinates for a virtual cursor to any other virtual reality computing devices in a real-world environment. For example, two users, each equipped with a virtual reality computing device including a near-eye display, may be present in the same environment. Each virtual reality computing device may be configured to present and move a virtual cursor as described above. Further, each virtual reality computing device may be configured to send spatial coordinates for each three-dimensional world-space position of its own virtual cursor to the other device. Upon receiving spatial coordinates, a virtual reality computing device may be configured to present a second virtual cursor via the near-eye display at a screen-space position corresponding to a three-dimensional world-space position defined by the spatial coordinates. Accordingly, each user may see their own cursor, as well as the cursor controlled by the other user, moving substantially in real-time.

Spatial coordinates may be sent from one virtual reality computing device to another in a variety of suitable ways. For example, each virtual reality computing device may include a communications interface, configured to allow the device to communicate with computer networks, including the Internet. Accordingly, virtual reality computing devices may send and receive spatial coordinates over the Internet, via a Wi-Fi connection, for example. Additionally, or alternatively, a communications interface may be configured to enable direct communication with another device, either wirelessly, via Bluetooth, near field communication (NFC), etc., or via a wired connection. Further, a virtual reality computing device may send and/or receive spatial coordinates substantially in real-time, allowing for near simultaneous presentation of a virtual cursor that is being controlled by a different device. In some implementations each virtual reality computing device may not be responsible for its own cursor position. In such implementations, a neutral computer may be used to coordinate both cursor positions, or one of the virtual reality computing devices may coordinate both cursor positions.

In some implementations, the spatial coordinates sent by each virtual reality computing device may be defined using a common coordinate system collaboratively used by each virtual reality computing device. For example, a user may download/create a digital map of the real-world environment in which both virtual reality computing devices are located, and upload the map to each device. Accordingly, the common coordinate system may be defined by the map, and spatial coordinates received by a virtual reality computing device may easily be translated into a three-dimensional world-space position of a virtual cursor by referring to the map. Additionally, or alternatively, each virtual reality computing device may be configured to, upon entering a new environment, automatically identify features, landmarks, and/or other anchor points present in the environment, and build its own internal coordinate system based on the identified features. Multiple virtual reality computing devices may then communicate and compare identified features in order to reconcile their internal coordinate systems, ultimately collaboratively generating the common coordinate system. In general, any suitable techniques may be used in order to ensure that each virtual reality computing device shares a common coordinate system by which spatial coordinates may be interpreted.

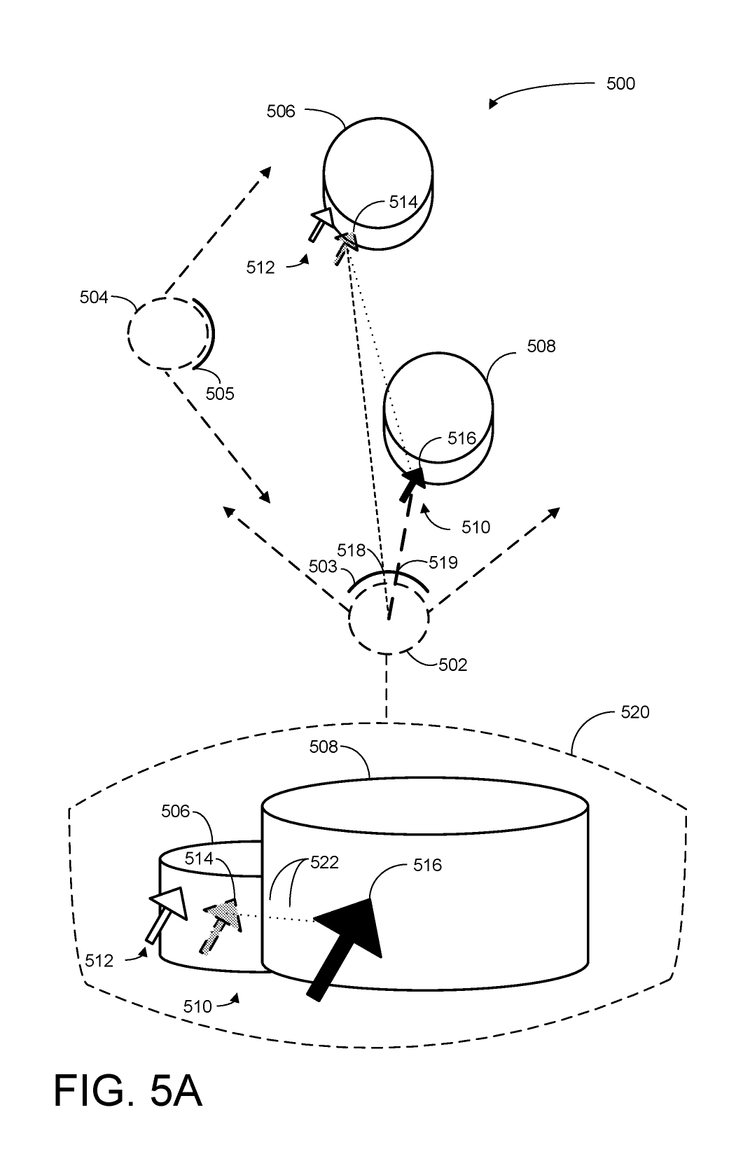

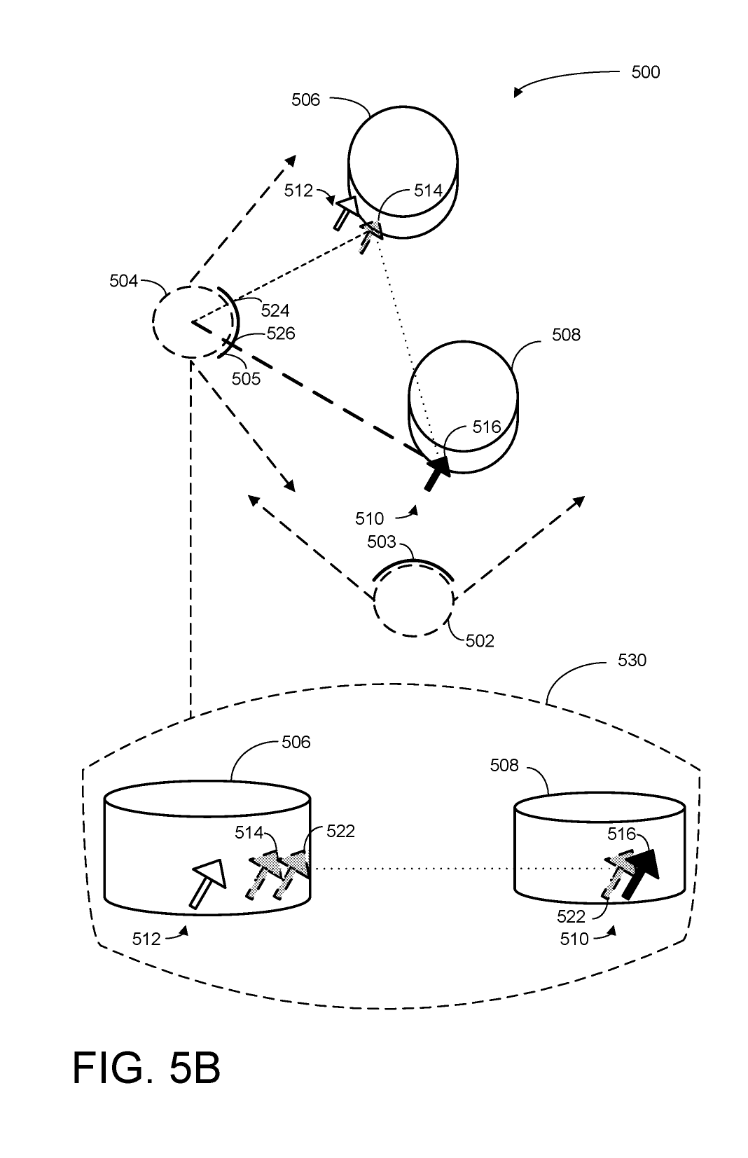

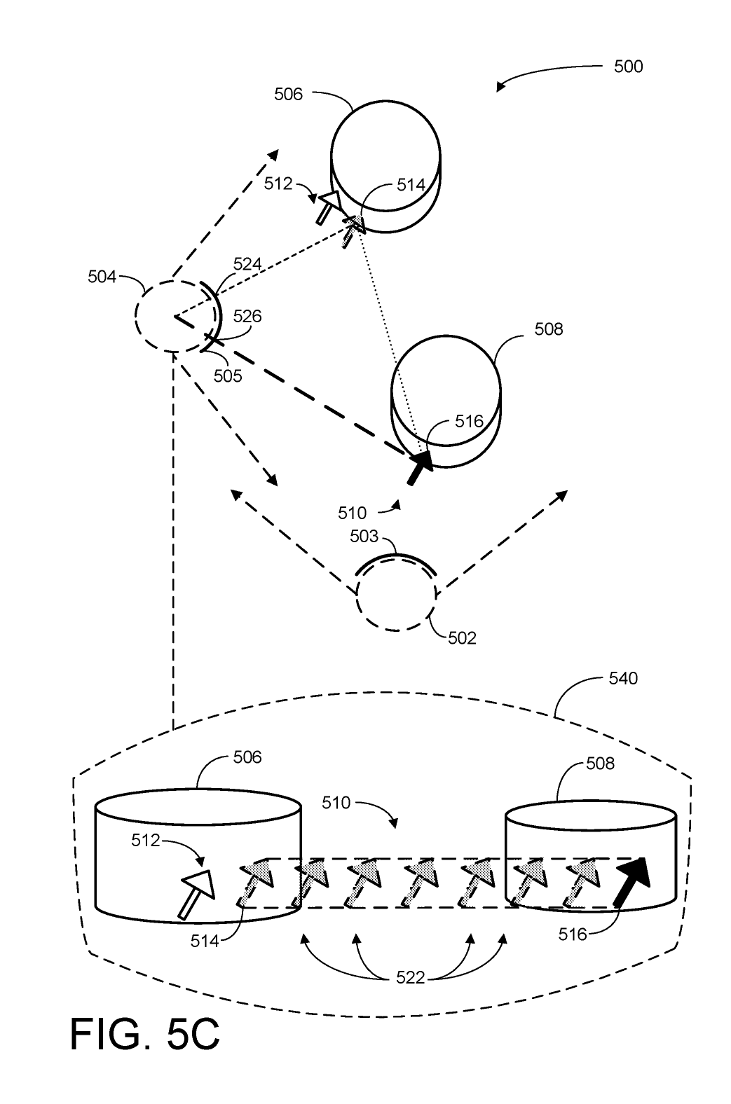

FIG. 5A schematically shows an environment 500 including a first user 502, who is using a first virtual reality computing device including a near-eye display 503, and a second user 504, who is using a second virtual reality computing device including a near-eye display 505. Environment 500 further includes first object 506 and second object 508. Environment 500 is similar to environment 400, in that it is shown with virtual content that is only visible to the users of the virtual reality computing devices. Specifically, environment 500 includes first virtual cursor 510, controlled by first user 502, and second virtual cursor 512, controlled by second user 504.

As shown, first cursor 510 is currently occupying second three-dimensional world-space position 516, after having moved from first three-dimensional world-space position 514, which is also shown in FIG. 5A as an outline. The virtual cursor is being presented by near-eye display 503 at second screen-space position 519, after previously being displayed at first screen-space position 518. Movement of the cursor through three-dimensional space is indicated by a dotted line connecting the three-dimensional world-space positions.

FIG. 5A also includes a field of view 520 of user 502. In other words, FIG. 5A shows movement of virtual cursor 510 from the first world-space position to the second world-space position as it appeared to user 502 via near-eye display 503. As shown, cursor 510 moved from first three-dimensional world-space position 514, where it was occluding first object 506, to second three-dimensional world-space position 516, where it is currently occluding second object 508.

Notably, from the perspective of user 502, first virtual cursor 510 was always occluding either first object 506 or second object 508 as it moved from position 514 to position 516.

As described above, each three-dimensional world-space position of a virtual cursor is determined based on the screen-space position of the cursor and its proximity to objects in the environment. Accordingly, the determination of a three-dimensional world-space position for a given virtual cursor will be inherently tied to the current perspective of the user controlling the cursor. For example, when virtual cursor 510 is at first screen-space position 518, the depth of the three-dimensional world-space position of the virtual cursor is equal to the distance between the first object and the first user's near-eye display. Similarly, when virtual cursor 510 is at second screen-space position 519, the depth of the three-dimensional world-space position of the virtual cursor is equal to the distance between the second object and the first user's near-eye display. Because virtual cursor 510 is always occluding either the first or the second objects during its movement from the perspective of user 502, the three-dimensional world-space position of the virtual cursor could abruptly jump from the depth of the first object to the depth of the second object if additional smoothing and/or attractive force modeling was not implemented.

This is illustrated in FIG. 5B. FIG. 5B again shows environment 500, in which first object 506, second object 508, virtual cursor 510, and virtual cursor 512 are visible. However, FIG. 5B shows movement of virtual cursor 510 from the perspective of second user 504. As shown, virtual cursor 510 moved from a first screen-space position 524 of near-eye display 505, corresponding to first three-dimensional world-space position 514, to second screen-space position 526, corresponding to second three-dimensional world-space position 516.

FIG. 5B also includes a field of view 530 of user 504 as seen through near-eye display 505. In other words, field of view 530 shows the movement of virtual cursor 510 through environment 500 from the perspective of user 504. Intermediate three-dimensional world-space positions 522 are shown in field of view 530 between the first and second screen-space positions. However, at the moment when virtual cursor 510 moved from occluding the first object to occluding the second object from the first user's perspective, the three-dimensional world-space position of the virtual cursor jumped, as described above. This would be perceived by the second user as an abrupt change in position of the cursor, which is illustrated by the non-continuous plurality of intermediate three-dimensional world-space positions 522 shown in FIG. 5B.

Abrupt and non-continuous movement of a virtual cursor as shown in FIG. 5B may be disconcerting for the second user. For example, during non-continuous cursor motion, the second user may have difficulty following the cursor's movements, especially in implementations where numerous objects are present, even while the cursor's motion appears continuous to the first user. Accordingly, virtual reality computing devices as described herein may be configured to perform smoothing on a non-continuous plurality of intermediate three-dimensional world-space positions, resulting in a continuous plurality of intermediate three-dimensional world-space positions. In other words, abrupt motion of a virtual cursor may be smoothed so as to appear continuous.

A virtual reality computing device may perform smoothing under a number of conditions. For example, the virtual reality computing device may perform smoothing upon detecting that a virtual cursor moves through three-dimensional space at greater than a threshold rate (i.e., the cursor moves from a starting point to an ending point in less than a threshold time), and/or determining that two sequential sets of spatial coordinates correspond to three-dimensional world-space positions more than a threshold distance apart.

Further, the virtual reality computing device may perform smoothing in a number of ways. For example, the virtual reality computing device may be configured to perform spatial smoothing and/or temporal smoothing of a non-continuous plurality of three-dimensional world-space positions. For example, during spatial smoothing, the virtual reality computing device may detect any gaps and/or discontinuities in the movement of a virtual cursor, and generate spatial coordinates for three-dimensional world-space positions within the gaps. Similarly, during temporal smoothing, the virtual reality computing device may detect that a virtual cursor moves through three-dimensional space at greater than a threshold speed. Accordingly, the virtual reality computing device may slow down the motion, by inserting additional positions into the non-continuous plurality and/or increasing the duration of the motion, for example. This may have the effect of reducing the speed at which the cursor moves. In general, a virtual reality computing device may detect a non-continuous plurality of world-space positions in any suitable way, and smooth the plurality using any suitable smoothing techniques.

FIG. 5C again shows environment 500, and includes a field of view 540 of user 504. Specifically, field of view 540 shows the virtual cursor movement illustrated in FIG. 5C after smoothing has been applied. As shown, the non-continuous plurality of intermediate three-dimensional world-space positions has been smoothed to a continuous plurality. Accordingly, FIG. 5C shows virtual cursor 510 moving through a continuous plurality of intermediate three-dimensional world-space positions between the first and second three-dimensional world-space positions. For example, the virtual reality computing device of either the first or second users may smooth the motion of the virtual cursor by adding new intermediate world-space positions for the virtual cursor between the first and second three-dimensional world-space positions, as described above.

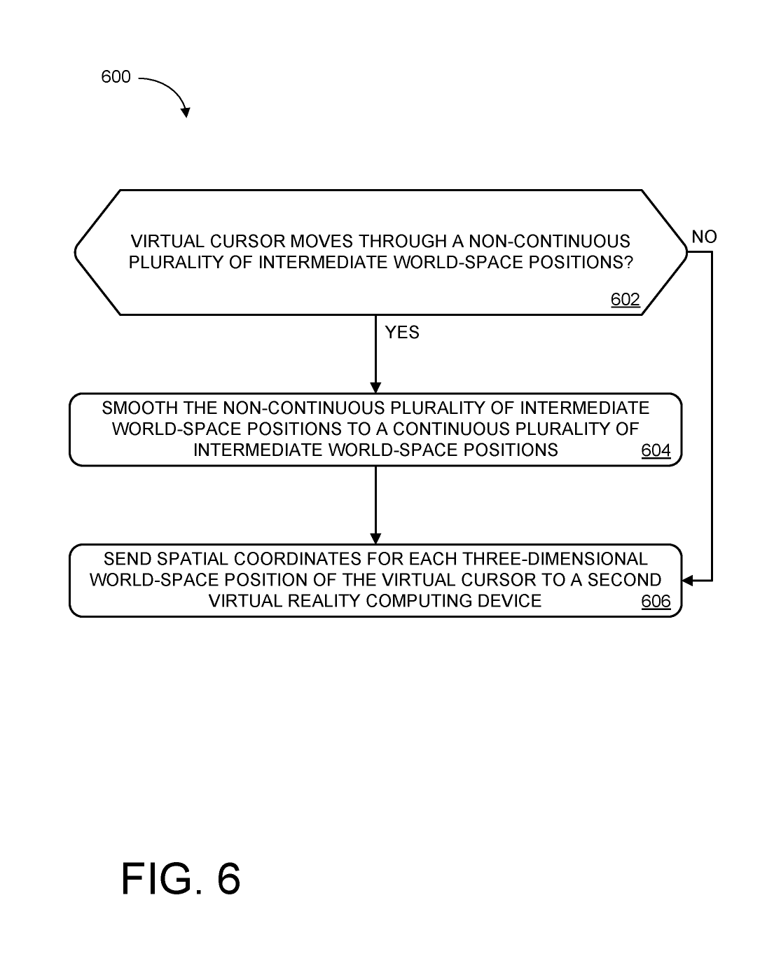

Smoothing of a non-continuous plurality of world-space positions may be performed either by a virtual reality computing device actively controlling a virtual cursor and sending spatial coordinates to a second device, by a virtual reality computing device receiving spatial coordinates, and/or by a neutral computing device coordinating cursor position for two or more virtual reality computing devices. FIG. 6 illustrates an example method 600 for sending spatial coordinates for a virtual cursor to a second virtual reality computing device in which smoothing is performed before the spatial coordinates are sent.

At 602, method 600 includes determining whether a virtual cursor moves through a non-continuous plurality of intermediate world-space positions. If YES, as in the case described with respect to FIGS. 5A-5C, method 600 proceeds to step 604, which includes smoothing the non-continuous plurality of intermediate world-space positions to a continuous plurality of world-space positions. Smoothing may be performed in a number of suitable ways, as described above. Upon smoothing, method 600 proceeds to 606. If NO at 602, as is the case for the cursor movement described with respect to FIGS. 4A-4D, method 600 proceeds to 606 without smoothing.

At 606, method 600 includes sending spatial coordinates for each three-dimensional world-space position of a virtual cursor to a second virtual reality computing device. Sending of spatial coordinates may occur in a variety of suitable ways, as described above. Upon receiving the spatial coordinates, the second virtual reality computing device may present a second cursor at screen-space positions corresponding to the three-dimensional world-space positions defined by the spatial coordinates.

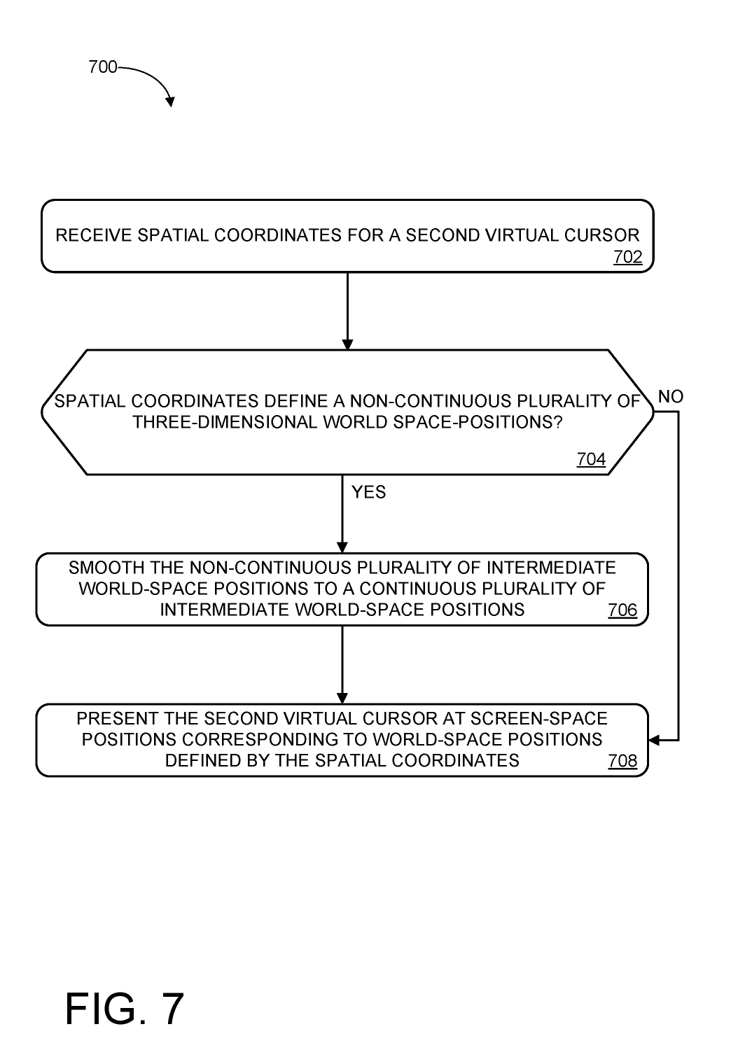

FIG. 7 illustrates an example method 700 for presenting a virtual cursor corresponding to received spatial coordinates, in the case where smoothing is performed by a virtual reality computing device that receives spatial coordinates. At 702, method 700 includes receiving spatial coordinates for a second virtual cursor. As described above, each set of spatial coordinates may be received in real-time, allowing for presentation of a second virtual cursor at substantially the same time as the cursor is controlled on a different virtual reality computing device.

At 704, method 700 includes determining whether the received spatial coordinates define a non-continuous plurality of three-dimensional world-space positions. If YES, as in the case described with respect to FIGS. 5A-5C, method 700 proceeds to step 706, which includes smoothing the non-continuous plurality of intermediate world-space positions to a continuous plurality of world-space positions. Smoothing may be performed in a number of suitable ways, as described above. Upon smoothing, method 700 proceeds to 708. If NO at 704, as is the case for the cursor movement described with respect to FIGS. 4A-4D, method 700 proceeds to 708 without smoothing.

At 708, method 700 includes presenting the second virtual cursor at screen-space positions corresponding to world-space positions defined by the spatial coordinates.

FIG. 8 shows aspects of an example virtual-reality computing system 800 including a near-eye display 802. The virtual-reality computing system 800 is a non-limiting example of the virtual-reality computing system 102 shown in FIG. 1, a virtual reality computing device incorporating near-eye display 200 of FIG. 2, virtual reality computing devices incorporating the near-eye displays shown in FIGS. 4A-4D and 5A-5C, and/or the computing system 900 shown in FIG. 9.

The virtual-reality computing system 800 may be configured to present any suitable type of virtual-reality experience. In some implementations, the virtual-reality experience includes a totally virtual experience in which the near-eye display 802 is opaque, such that the wearer is completely absorbed in the virtual-reality imagery provided via the near-eye display 802.

In some implementations, the virtual-reality experience includes an augmented-reality experience in which the near-eye display 802 is wholly or partially transparent from the perspective of the wearer, to give the wearer a clear view of a surrounding physical space. In such a configuration, the near-eye display 802 is configured to direct display light to the user's eye(s) so that the user will see augmented-reality objects that are not actually present in the physical space. In other words, the near-eye display 802 may direct display light to the user's eye(s) while light from the physical space passes through the near-eye display 802 to the user's eye(s). As such, the user's eye(s) simultaneously receive light from the physical environment and display light.

In such augmented-reality implementations, the virtual-reality computing system 800 may be configured to visually present augmented-reality objects that appear body-locked and/or world-locked. A body-locked augmented-reality object may appear to move along with a perspective of the user as a pose (e.g., six degrees of freedom (DOF): x, y, z, yaw, pitch, roll) of the virtual-reality computing system 800 changes. As such, a body-locked, augmented-reality object may appear to occupy the same portion of the near-eye display 802 and may appear to be at the same distance from the user, even as the user moves in the physical space. Alternatively, a world-locked, augmented-reality object may appear to remain in a fixed location in the physical space, even as the pose of the virtual-reality computing system 800 changes. When the virtual-reality computing system 800 visually presents world-locked, augmented-reality objects, such a virtual-reality experience may be referred to as a mixed-reality experience.

In some implementations, the opacity of the near-eye display 802 is controllable dynamically via a dimming filter. A substantially see-through display, accordingly, may be switched to full opacity for a fully immersive virtual-reality experience.

The virtual-reality computing system 800 may take any other suitable form in which a transparent, semi-transparent, and/or non-transparent display is supported in front of a viewer's eye(s). Further, implementations described herein may be used with any other suitable computing device, including but not limited to wearable computing devices, mobile computing devices, laptop computers, desktop computers, smart phones, tablet computers, etc.

Any suitable mechanism may be used to display images via the near-eye display 802. For example, the near-eye display 802 may include image-producing elements located within lenses 806. As another example, the near-eye display 802 may include a display device, such as a liquid crystal on silicon (LCOS) device or OLED microdisplay located within a frame 808. In this example, the lenses 806 may serve as, or otherwise include, a light guide for delivering light from the display device to the eyes of a wearer. Additionally or alternatively, the near-eye display 802 may present left-eye and right-eye virtual-reality images via respective left-eye and right-eye displays.

The virtual-reality computing system 800 includes an on-board computer 804 configured to perform various operations related to receiving user input (e.g., gesture recognition, eye gaze detection), visual presentation of virtual-reality images on the near-eye display 802, and other operations described herein. In some implementations, some to all of the computing functions described above, may be performed off board.

The virtual-reality computing system 800 may include various sensors and related systems to provide information to the on-board computer 804. Such sensors may include, but are not limited to, one or more inward facing image sensors 810A and 810B, one or more outward facing image sensors 812A and 812B, an inertial measurement unit (IMU) 814, and one or more microphones 816. The one or more inward facing image sensors 810A, 810B may be configured to acquire gaze tracking information from a wearer's eyes (e.g., sensor 810A may acquire image data for one of the wearer's eye and sensor 810B may acquire image data for the other of the wearer's eye).

The on-board computer 804 may be configured to determine gaze directions of each of a wearer's eyes in any suitable manner based on the information received from the image sensors 810A, 810B. The one or more inward facing image sensors 810A, 810B, and the on-board computer 804 may collectively represent a gaze detection machine configured to determine a wearer's gaze target on the near-eye display 802. In other implementations, a different type of gaze detector/sensor may be employed to measure one or more gaze parameters of the user's eyes. Examples of gaze parameters measured by one or more gaze sensors that may be used by the on-board computer 804 to determine an eye gaze sample may include an eye gaze direction, head orientation, eye gaze velocity, eye gaze acceleration, change in angle of eye gaze direction, and/or any other suitable tracking information. In some implementations, eye gaze tracking may be recorded independently for both eyes.

The one or more outward facing image sensors 812A, 812B may be configured to measure physical environment attributes of a physical space. In one example, image sensor 812A may include a visible-light camera configured to collect a visible-light image of a physical space. Further, the image sensor 812B may include a depth camera configured to collect a depth image of a physical space. More particularly, in one example, the depth camera is an infrared time-of-flight depth camera. In another example, the depth camera is an infrared structured light depth camera.

Data from the outward facing image sensors 812A, 812B may be used by the on-board computer 804 to detect movements, such as gesture-based inputs or other movements performed by a wearer or by a person or physical object in the physical space. In one example, data from the outward facing image sensors 812A, 812B may be used to detect a wearer input performed by the wearer of the virtual-reality computing system 800, such as a gesture. Data from the outward facing image sensors 812A, 812B may be used by the on-board computer 804 to determine direction/location and orientation data (e.g., from imaging environmental features) that enables position/motion tracking of the virtual-reality computing system 800 in the real-world environment. In some implementations, data from the outward facing image sensors 812A, 812B may be used by the on-board computer 804 to construct still images and/or video images of the surrounding environment from the perspective of the virtual-reality computing system 800.

The IMU 814 may be configured to provide position and/or orientation data of the virtual-reality computing system 800 to the on-board computer 804. In one implementation, the IMU 814 may be configured as a three-axis or three-degree of freedom (3DOF) position sensor system. This example position sensor system may, for example, include three gyroscopes to indicate or measure a change in orientation of the virtual-reality computing system 800 within 3D space about three orthogonal axes (e.g., roll, pitch, and yaw).

In another example, the IMU 814 may be configured as a six-axis or six-degree of freedom (6DOF) position sensor system. Such a configuration may include three accelerometers and three gyroscopes to indicate or measure a change in location of the virtual-reality computing system 800 along three orthogonal spatial axes (e.g., x, y, and z) and a change in device orientation about three orthogonal rotation axes (e.g., yaw, pitch, and roll). In some implementations, position and orientation data from the outward facing image sensors 812A, 812B and the IMU 814 may be used in conjunction to determine a position and orientation (or 6DOF pose) of the virtual-reality computing system 800.

The virtual-reality computing system 800 may also support other suitable positioning techniques, such as GPS or other global navigation systems. Further, while specific examples of position sensor systems have been described, it will be appreciated that any other suitable sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., WIFI antennas/interfaces), etc.

The one or more microphones 816 may be configured to measure sound in the physical space. Data from the one or more microphones 816 may be used by the on-board computer 804 to recognize voice commands provided by the wearer to control the virtual-reality computing system 800.

The on-board computer 804 may include a logic machine and a storage machine, discussed in more detail below with respect to FIG. 8, in communication with the near-eye display 802 and the various sensors of the virtual-reality computing system 800.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. In particular, computing system 900 may perform the virtual cursor presentation and movement functions described herein. Computing system 900 is shown in simplified form. Computing system 900 may take the form of one or more virtual reality computing devices, personal computers, server computers, tablet computers, home-entertainment computers, network computing devices, gaming devices, mobile computing devices, mobile communication devices (e.g., smart phone), and/or other computing devices.

Computing system 900 includes a logic machine 902 and a storage machine 904. Computing system 900 may optionally include a display subsystem 906, input subsystem 908, communications interface 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic machine 902 executing instructions held by storage machine 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 906 may be used to present a visual representation of data held by storage machine 904. This visual representation may take the form of a graphical user interface (GUI) including a virtual cursor. As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. For example, display subsystem may take the form of a near-eye display configured to present virtual cursors and other virtual imagery as described above. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communications interface 910 may be configured to communicatively couple computing system 900 with one or more other computing devices. For example, communications interface 910 may be used to send and/or receive spatial coordinates and/or coordinate system data with one or more other computing systems. Communications interface 910 may include wired and/or wireless communication devices compatible with one or more different communication protocols. As non-limiting examples, the communications interface may be configured for communication via a wireless telephone network, or a wired or wireless local- or wide-area network. In some embodiments, the communications interface may allow computing system 900 to send and/or receive messages to and/or from other devices via a network such as the Internet.

In an example, a virtual reality computing device comprises: a near-eye display; a logic machine; and a storage machine holding instructions executable by the logic machine to: via the near-eye display, present a virtual cursor at a first screen-space position that occludes a world-space position of a first object from a user perspective, where the virtual cursor is assigned a first three-dimensional world-space position based on the first screen-space position and the world-space position of the first object; based on receiving an input to move the virtual cursor, move the virtual cursor from the first screen-space position to a second screen-space position that occludes a world-space position of a second object from the user perspective, where the virtual cursor is assigned a second three-dimensional world-space position based on the second screen-space position and the world-space position of the second object; and while the virtual cursor is presented at an intermediate screen-space position between the first and second screen-space positions, assign an intermediate three-dimensional world-space position to the virtual cursor based on the intermediate screen-space position and simulated attractive forces for each of the first and second objects. In this example or any other example, the intermediate screen-space position is one of a continuous plurality of intermediate screen-space positions, and an intermediate three-dimensional world-space position is assigned to each of the continuous plurality of intermediate screen-space positions based on a corresponding screen-space position and the simulated attractive forces for each of the first and second objects. In this example or any other example, the intermediate three-dimensional world-space position is intersected by a ray extending through the user perspective and the intermediate screen-space position. In this example or any other example, a depth of the intermediate three-dimensional world-space position is calculated based on the simulated attractive forces for each of the first and second objects, and a magnitude of a simulated attractive force for a particular object is inversely proportional to a shortest distance between the particular object and the ray extending through the intermediate screen-space position. In this example or any other example, the magnitude of the simulated attractive force for the particular object is also proportional to a size of the particular object. In this example or any other example, each three-dimensional world-space position of the virtual cursor is defined by at least three spatial coordinates. In this example or any other example, the virtual reality computing device further comprises a communications interface, and the instructions are further executable to send spatial coordinates for each three-dimensional world-space position of the virtual cursor to a second virtual reality computing device via the communications interface. In this example or any other example, the spatial coordinates are defined using a common coordinate system collaboratively used by the virtual reality computing device and the second virtual reality computing device. In this example or any other example, based on receiving spatial coordinates for a second virtual cursor from the second virtual reality computing device, the instructions are further executable to present the second virtual cursor via the near-eye display at a screen-space position corresponding to a three-dimensional world-space position defined by the spatial coordinates. In this example or any other example, the instructions are further executable to, based on the virtual cursor moving from the first three-dimensional world-space position to the second three-dimensional world-space position through a non-continuous plurality of intermediate three-dimensional world-space positions, smooth the non-continuous plurality of intermediate three-dimensional world-space positions to a continuous plurality of intermediate three-dimensional world-space positions, and send spatial coordinates corresponding to the continuous plurality of intermediate three-dimensional world-space positions to the second virtual reality computing device. In this example or any other example, the instructions are further executable to, based on receiving spatial coordinates from the second virtual reality computing device defining a non-continuous plurality of three-dimensional world-space positions of a second virtual cursor, smooth the non-continuous plurality of world-space positions to a continuous plurality of world-space positions, and sequentially present the second virtual cursor via the near-eye display at each of a continuous plurality of screen-space positions corresponding to the continuous plurality of three-dimensional world-space positions. In this example or any other example, the first object or the second object is a physical object present in a real-world environment of the virtual reality computing device. In this example or any other example, the first object or the second object is a virtual object generated by the virtual reality computing device and displayed via the near-eye display.

In an example, a method for moving a virtual cursor on a virtual reality computing device including a display comprises: presenting the virtual cursor at a first screen-space position of the display that occludes a world-space position of a first object from a user perspective, where the virtual cursor is assigned a first three-dimensional world-space position based on the first screen-space position and the world-space position of the first object; based on the virtual reality computing device receiving an input to move the virtual cursor, moving the virtual cursor from the first screen-space position to a second screen-space position that occludes a world-space position of a second object from the user perspective, where the virtual cursor is assigned a second three-dimensional world-space position based on the second screen-space position and the world-space position of the second object; and while the virtual cursor is presented at an intermediate screen-space position between the first and second screen-space positions, assigning an intermediate three-dimensional world-space position to the virtual cursor based on the intermediate screen-space position and simulated attractive forces for each of the first and second objects. In this example or any other example, the intermediate three-dimensional world-space position is intersected by a ray extending through the user perspective and the intermediate screen-space position. In this example or any other example, a depth of the intermediate three-dimensional world-space position is calculated based on the simulated attractive forces for each of the first and second objects, and a magnitude of a simulated attractive force for a particular object is proportional to a size of the particular object and inversely proportional to a shortest distance between the particular object and the ray extending through the intermediate screen-space position. In this example or any other example, the method further comprises sending spatial coordinates corresponding to each three-dimensional world-space position of the virtual cursor to a second virtual reality computing device via a communications interface of the virtual reality computing device. In this example or any other example, based on receiving spatial coordinates for a second virtual cursor from the second virtual reality computing device, the method further comprises presenting the second virtual cursor at a screen-space position corresponding to a three-dimensional world-space position defined by the spatial coordinates. In this example or any other example, based on the virtual cursor moving from the first three-dimensional world-space position to the second three-dimensional world-space position through a non-continuous plurality of intermediate three-dimensional world-space positions, the method further comprises smoothing the non-continuous plurality of intermediate three-dimensional world-space positions to a continuous plurality of intermediate three-dimensional world-space positions, and sending spatial coordinates to the second virtual reality computing device defining the continuous plurality of intermediate three-dimensional world-space positions.

In an example, a virtual reality computing device comprises: a near-eye display; a logic machine; and a storage machine holding instructions executable by the logic machine to: via the near-eye display, present a virtual cursor at a first screen-space position that occludes a world-space position of a first object from a user perspective, where the virtual cursor is presented so as to appear from the user perspective to occupy a first three-dimensional virtual position; based on receiving an input to move the virtual cursor, move the virtual cursor from the first screen-space position to a second screen-space position that occludes a world-space position of a second object from the user perspective, where the virtual cursor is presented so as to appear from the user perspective to occupy a second three-dimensional virtual position, the second three-dimensional virtual position having a different virtual depth than a virtual depth of the first three-dimensional virtual position; and while the virtual cursor is presented at an intermediate screen-space position between the first and second screen-space positions, for each of the first and second objects, apply a simulated attractive force to the virtual cursor, and present the virtual cursor such that the virtual cursor appears to occupy an intermediate three-dimensional virtual position at an intermediate virtual depth calculated based on the applied simulated attractive forces.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A virtual reality computing device, comprising:
a near-eye display;
a logic machine; and
a storage machine holding instructions executable by the logic machine to:
via the near-eye display, present a virtual cursor at a first screen-space position that occludes a world-space position of a first object from a user perspective, where the virtual cursor is assigned a first three-dimensional world-space position based on the first screen-space position and the world-space position of the first object;
based on receiving an input to move the virtual cursor, move the virtual cursor from the first screen-space position to a second screen-space position that occludes a world-space position of a second object from the user perspective, where the virtual cursor is assigned a second three-dimensional world-space position based on the second screen-space position and the world-space position of the second object; and
while the virtual cursor is presented at an intermediate screen-space position between the first and second screen-space positions, assign an intermediate three-dimensional world-space position to the virtual cursor based on the intermediate screen-space position and simulated attractive forces for each of the first and second objects.

2. The virtual reality computing device of claim 1, where the intermediate screen-space position is one of a continuous plurality of intermediate screen-space positions, and where an intermediate three-dimensional world-space position is assigned to each of the continuous plurality of intermediate screen-space positions based on a corresponding screen-space position and the simulated attractive forces for each of the first and second objects.

3. The virtual reality computing device of claim 1, where the intermediate three-dimensional world-space position is intersected by a ray extending through the user perspective and the intermediate screen-space position.

4. The virtual reality computing device of claim 3, where a depth of the intermediate three-dimensional world-space position is calculated based on the simulated attractive forces for each of the first and second objects, and a magnitude of a simulated attractive force for a particular object is inversely proportional to a shortest distance between the particular object and the ray extending through the intermediate screen-space position.

5. The virtual reality computing device of claim 4, where the magnitude of the simulated attractive force for the particular object is also proportional to a size of the particular object.

6. The virtual reality computing device of claim 1, where each three-dimensional world-space position of the virtual cursor is defined by at least three spatial coordinates.

7. The virtual reality computing device of claim 6, further comprising a communications interface, and where the instructions are further executable to send spatial coordinates for each three-dimensional world-space position of the virtual cursor to a second virtual reality computing device via the communications interface.

8. The virtual reality computing device of claim 7, where the spatial coordinates are defined using a common coordinate system collaboratively used by the virtual reality computing device and the second virtual reality computing device.

9. The virtual reality computing device of claim 7, where based on receiving spatial coordinates for a second virtual cursor from the second virtual reality computing device, the instructions are further executable to present the second virtual cursor via the near-eye display at a screen-space position corresponding to a three-dimensional world-space position defined by the spatial coordinates.

10. The virtual reality computing device of claim 7, where the instructions are further executable to, based on the virtual cursor moving from the first three-dimensional world-space position to the second three-dimensional world-space position through a non-continuous plurality of intermediate three-dimensional world-space positions, smooth the non-continuous plurality of intermediate three-dimensional world-space positions to a continuous plurality of intermediate three-dimensional world-space positions, and send spatial coordinates corresponding to the continuous plurality of intermediate three-dimensional world-space positions to the second virtual reality computing device.

11. The virtual reality computing device of claim 7, where the instructions are further executable to, based on receiving spatial coordinates from the second virtual reality computing device defining a non-continuous plurality of three-dimensional world-space positions of a second virtual cursor, smooth the non-continuous plurality of world-space positions to a continuous plurality of world-space positions, and sequentially present the second virtual cursor via the near-eye display at each of a continuous plurality of screen-space positions corresponding to the continuous plurality of three-dimensional world-space positions.

12. The virtual reality computing device of claim 1, where the first object or the second object is a physical object present in a real-world environment of the virtual reality computing device.

13. The virtual reality computing device of claim 1, where the first object or the second object is a virtual object generated by the virtual reality computing device and displayed via the near-eye display.

14. A method for moving a virtual cursor on a virtual reality computing device including a display, comprising:
presenting the virtual cursor at a first screen-space position of the display that occludes a world-space position of a first object from a user perspective, where the virtual cursor is assigned a first three-dimensional world-space position based on the first screen-space position and the world-space position of the first object;
based on the virtual reality computing device receiving an input to move the virtual cursor, moving the virtual cursor from the first screen-space position to a second screen-space position that occludes a world-space position of a second object from the user perspective, where the virtual cursor is assigned a second three-dimensional world-space position based on the second screen-space position and the world-space position of the second object; and
while the virtual cursor is presented at an intermediate screen-space position between the first and second screen-space positions, assigning an intermediate three-dimensional world-space position to the virtual cursor based on the intermediate screen-space position and simulated attractive forces for each of the first and second objects.

15. The method of claim 14, where the intermediate three-dimensional world-space position is intersected by a ray extending through the user perspective and the intermediate screen-space position.

16. The method of claim 15, where a depth of the intermediate three-dimensional world-space position is calculated based on the simulated attractive forces for each of the first and second objects, and a magnitude of a simulated attractive force for a particular object is proportional to a size of the particular object and inversely proportional to a shortest distance between the particular object and the ray extending through the intermediate screen-space position.

17. The method of claim 14, further comprising sending spatial coordinates corresponding to each three-dimensional world-space position of the virtual cursor to a second virtual reality computing device via a communications interface of the virtual reality computing device.

18. The method of claim 17, where based on receiving spatial coordinates for a second virtual cursor from the second virtual reality computing device, the method further comprises presenting the second virtual cursor at a screen-space position corresponding to a three-dimensional world-space position defined by the spatial coordinates.

19. The method of claim 17, where based on the virtual cursor moving from the first three-dimensional world-space position to the second three-dimensional world-space position through a non-continuous plurality of intermediate three-dimensional world-space positions, the method further comprises smoothing the non-continuous plurality of intermediate three-dimensional world-space positions to a continuous plurality of intermediate three-dimensional world-space positions, and sending spatial coordinates to the second virtual reality computing device defining the continuous plurality of intermediate three-dimensional world-space positions.

20. A virtual reality computing device, comprising:
a near-eye display;
a logic machine; and
a storage machine holding instructions executable by the logic machine to:
via the near-eye display, present a virtual cursor at a first screen-space position that occludes a world-space position of a first object from a user perspective, where the virtual cursor is presented so as to appear from the user perspective to occupy a first three-dimensional virtual position;
based on receiving an input to move the virtual cursor, move the virtual cursor from the first screen-space position to a second screen-space position that occludes a world-space position of a second object from the user perspective, where the virtual cursor is presented so as to appear from the user perspective to occupy a second three-dimensional virtual position, the second three-dimensional virtual position having a different virtual depth than a virtual depth of the first three-dimensional virtual position; and
while the virtual cursor is presented at an intermediate screen-space position between the first and second screen-space positions, for each of the first and second objects, apply a simulated attractive force to the virtual cursor, and present the virtual cursor such that the virtual cursor appears to occupy an intermediate three-dimensional virtual position at an intermediate virtual depth calculated based on the applied simulated attractive forces.
